(19) United States
(12) Patent Application Publication
(10) Pub. No.: US 2017/0015487 A1
(43) Pub. Date: Jan. 19, 2017

(54) HIDDEN RECEPTACLE WITH MOVABLE COVERING

(71) Applicant: Ornata LLC, Los Angeles, CA (US)

(72) Inventors: Kishani Perera, Los Angeles, CA (US); Davy Newkirk, Los Angeles, CA (US)

(21) Appl. No.: 14/801,489

(22) Filed: Jul. 16, 2015

(51) Int. Cl. B65D 81/36; F21V 35/00

(52) U.S. Cl. CPC B65D 81/365; F21V 35/00

(57) ABSTRACT

An apparatus constructed of brass with a hidden receptacle on its back is shaped to resemble an insect, such as a scarab. Wings on the back of the apparatus can be moved or removed to reveal the hidden receptacle. The hidden receptacle can be sized to hold a votive or tea candle.

### BACKGROUND

The application relates generally to an apparatus with decorative and functional features that can hold a candle, or other objects.

The preceding description is not to be construed as an admission that any of the description is prior art relative to the present invention.

### SUMMARY OF THE INVENTION

In one aspect, an apparatus for containing materials includes a body part that is configured to represent an insect, a plurality of wing parts that are movably attached to the body part and configured to swing in a substantially horizontal and coordinated manner between a closed position and an open position, and a receptacle in the body part. The receptacle is substantially covered by the wing parts, when the wing parts are in the closed position. The receptacle is substantially uncovered when the wing parts are in the open position.

In further aspects, the apparatus further includes a head part attached and adjacent to one end of the body. In further aspects, the apparatus further includes a plurality of leg parts attached and extending laterally from both sides of the body part. In further aspects, the apparatus resembles a scarab. In further aspects, the apparatus resembles an insect in the family of Coleoptera. In further aspects, the apparatus resembles an insect from the group consisting of the families of Cicadellidae, Scutelleridae, and Pentatomoidea. In further aspects, the receptacle is about 1.5 inches in diameter. In further aspects, the apparatus is at least partly constructed of glass. In further aspects, the apparatus is at least partly constructed of brass. In further aspects, the plurality of wing parts includes two wing parts that are at least partly constructed of brass.

In one aspect, an apparatus for containing materials includes a body part that is configured to represent an insect, a wing part that is removably mated to the body part, and a receptacle in the body part. The receptacle is substantially covered by the wing part when the wing part is mated to the body part. The receptacle is substantially uncovered when the wing part is not mated to the body part.

In further aspects, the wing part and the body part have at least two alignment protrusions and corresponding alignment spaces. In further aspects, the receptacle opening diameter is about 1.5 inches. In further aspects, the receptacle opening diameter is substantially larger than 1.5 inches. In further aspects, the body part and wing part are both constructed at least partly of brass. In further aspects, the apparatus resembles a scarab.

In one aspect, an apparatus for holding a candle and configured to represent a scarab, includes a body part constructed of brass, a head part on one end of the body part, a plurality of leg parts that extend laterally from both sides of the body part, a pair of movable wing parts constructed of brass that are rotationally attached to a back of the body part, and a receptacle in the back of the body part about 1.5 inches in diameter. The receptacle is substantially covered by the pair of movable wings when the wing parts are in a closed position. The receptacle is substantially uncovered when the wing parts are in an open position.

In further aspects, the apparatus further includes a gear mechanism that connects the pair of movable wing parts. The apparatus and gear mechanism are configured to synchronize movement of the pair of movable wing parts between the closed position and the open position.

In one aspect, an apparatus with a receptacle configured to represent a scarab, includes a body part constructed of brass, a head part on one end of the body part, a first protrusion on an end of the body part opposite the head part, a plurality of leg parts that extend laterally from both sides of the body part, a wing part constructed of brass, and a second protrusion on the wing part. The first protrusion and the second protrusion are configured to allow the wing part to removably mate to a back of the body part. A receptacle in the back of the body part is substantially covered by the wing part when the wing part is mated to the back of the body part. The receptacle is substantially uncovered when the wing part is not mated to the back of the body part.

The foregoing specific aspects are illustrative of those which can be achieved and are not intended to be exhaustive or limiting of the possible advantages that can be realized. Thus, the objects and advantages will be apparent from the description herein or can be learned from practicing the invention, both as embodied herein or as modified in view of any variations which may be apparent to those skilled in the art. Accordingly the present invention resides in the novel parts, constructions, arrangements, combinations and improvements herein shown and described.

### BRIEF DESCRIPTION OF THE DRAWINGS

The foregoing features and other aspects are explained in the following description taken in conjunction with the accompanying figures wherein:

FIGS. 1-8 illustrate various embodiments of the described and disclosed apparatus.

It is understood that the drawings are for illustration only and are not limiting.

### DETAILED DESCRIPTION OF THE DRAWINGS

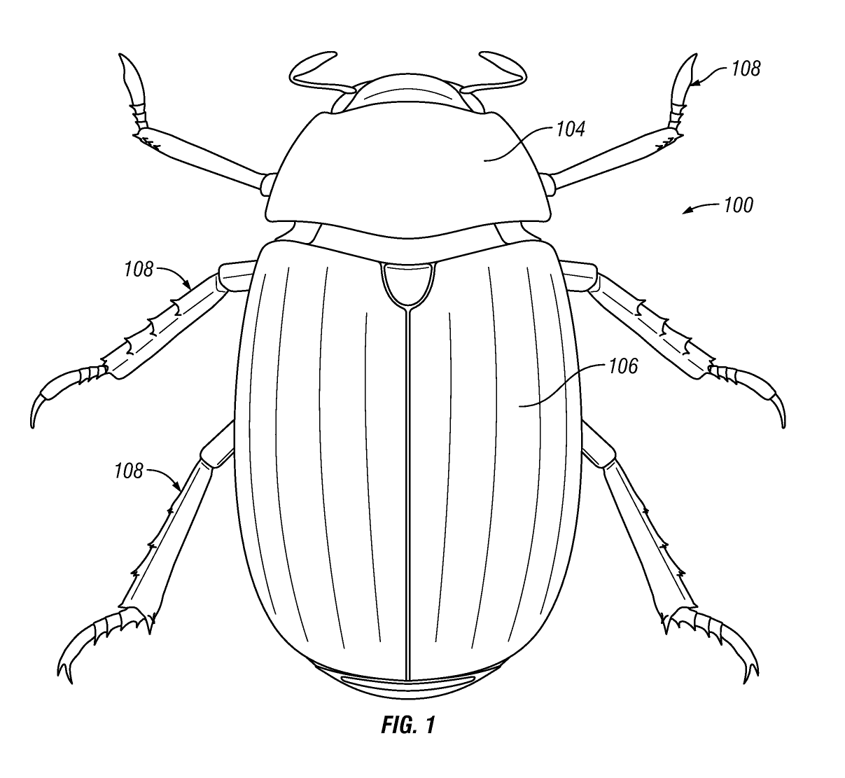

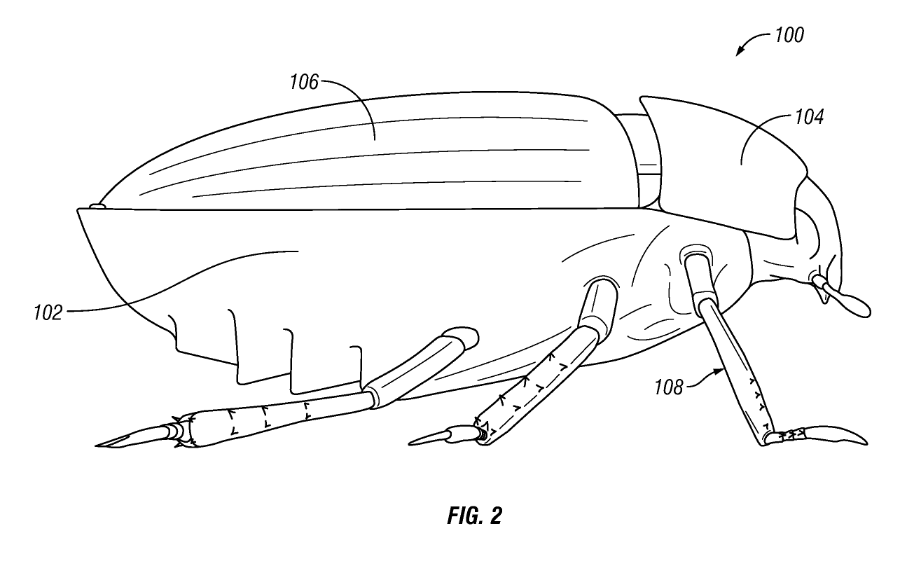

Referring generally to FIGS. 1 and 2, an apparatus 100 with a hidden receptacle is shaped to represent an insect, such as a scarab. The apparatus 100 includes a body part 102, a head part 104, and one or more wing parts 106. The apparatus 100 also includes multiple leg parts 108, that extend from both sides of the body.

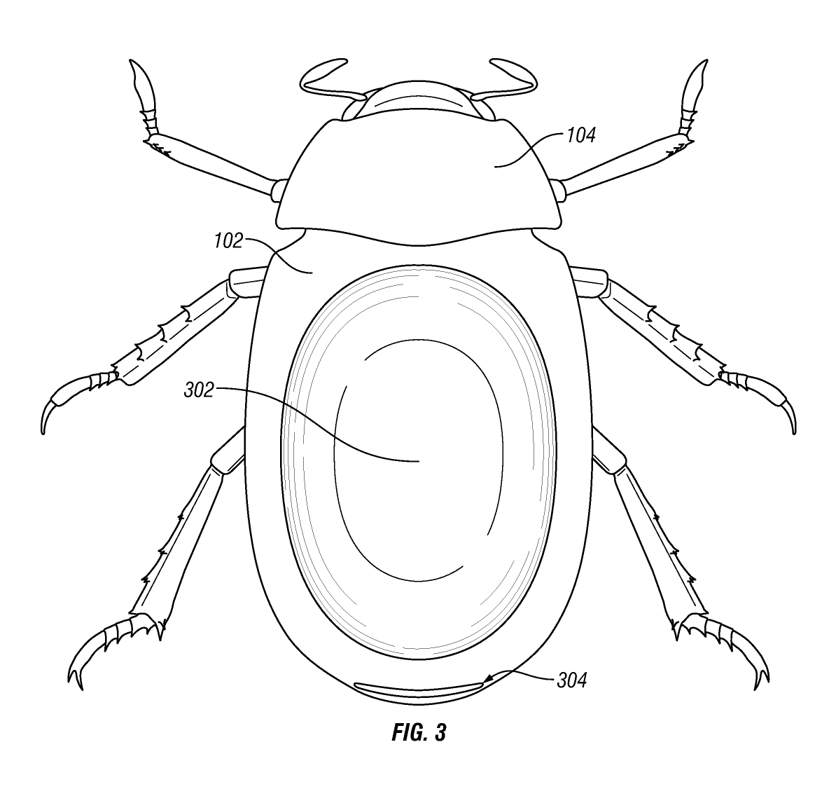

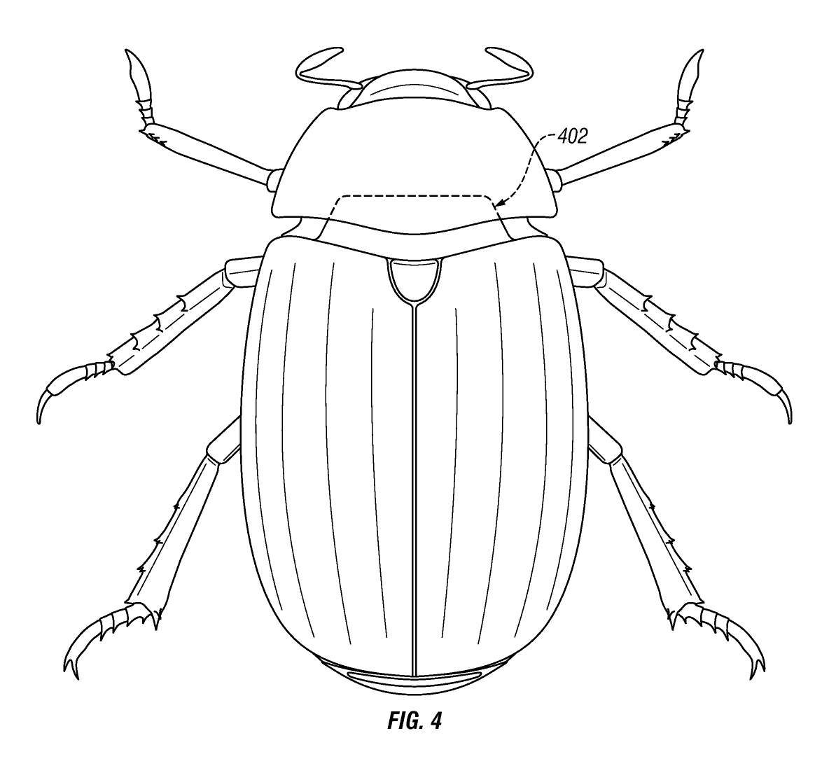

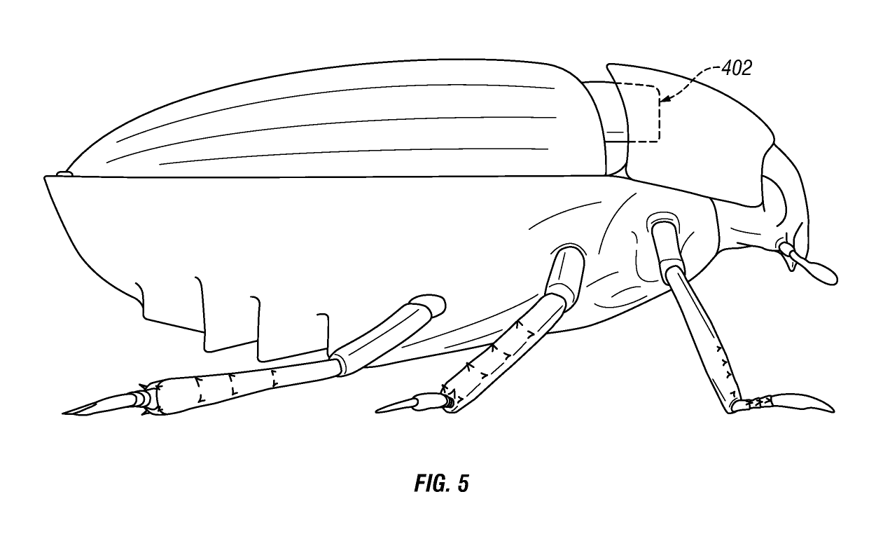

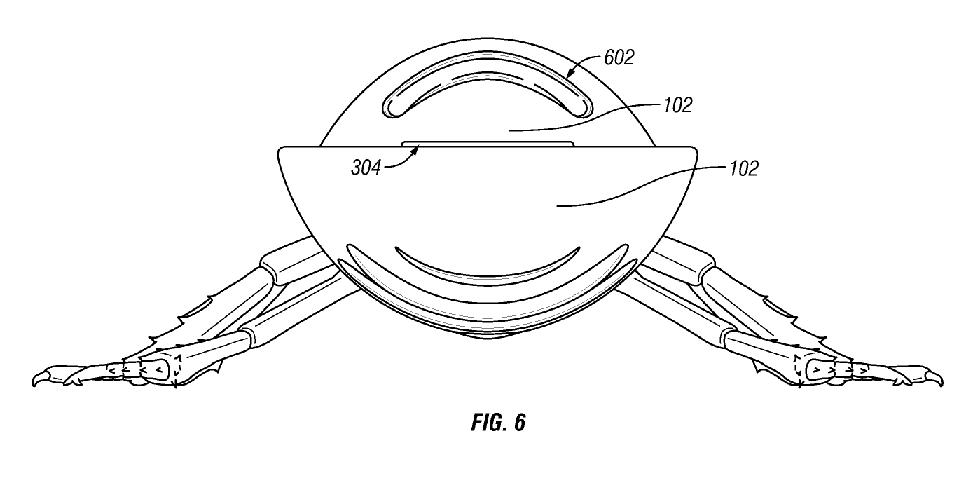

In one embodiment, as illustrated in FIG. 3, the wing parts can be removed from the body part 102, revealing a receptacle 302. In this embodiment, the wing parts are removably mated to the body part, and protrusions on the wing parts and on the body part assist in that removable matting. As an example, one protrusion 304 on one end of the body part that is opposite the head part, helps to hold the wing parts and body part in position. As illustrated in FIGS. 4 and 5, another protrusion 402 on the wing parts, also helps to hold the wing parts and body part in position. FIG. 6 further illustrates the configuration of protrusion 304 on body part 102. FIG. 6 also illustrates a space 602 on body part 102 that corresponds with protrusion 402 on the wing parts.

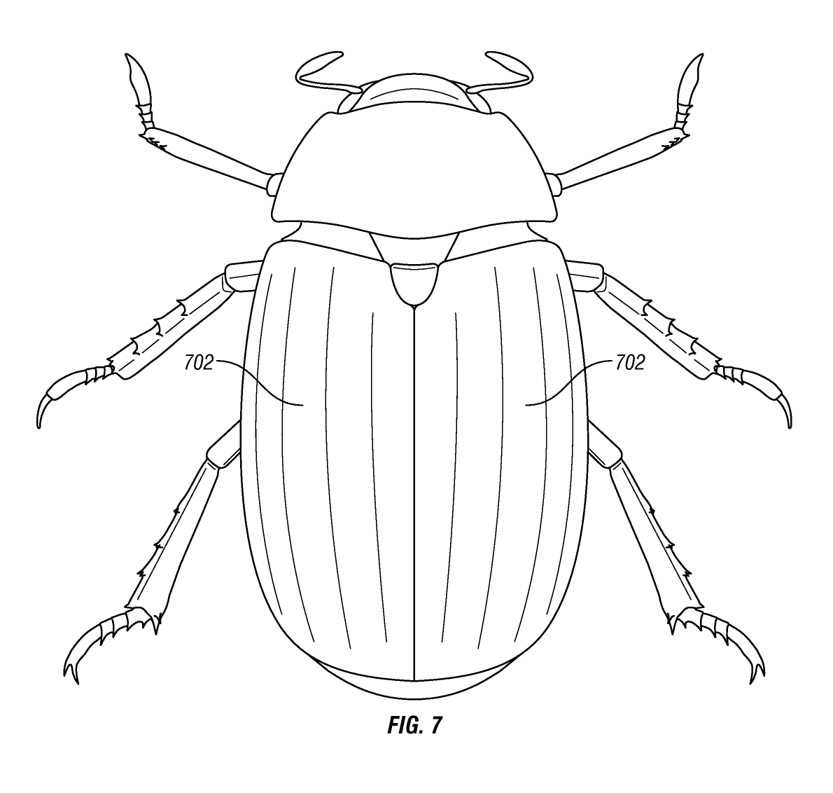

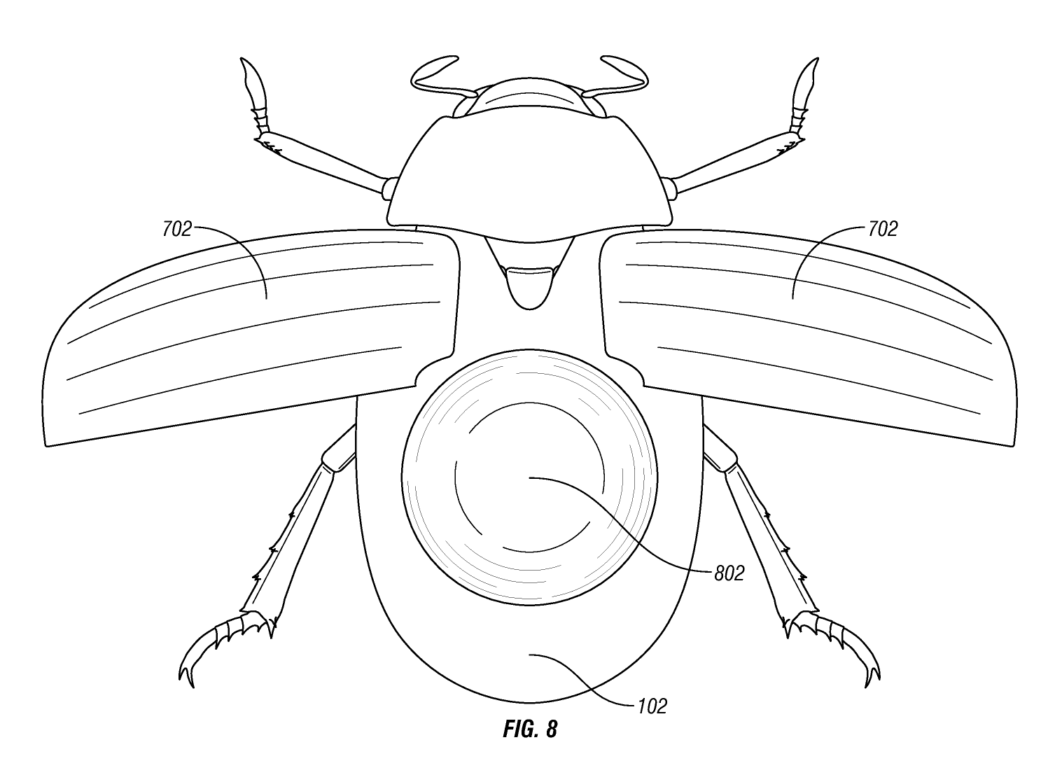

Another embodiment is illustrated in FIGS. 7 and 8, where wing parts 702 are movably connected to body part 102 and configured to rotate from a closed position, as illustrated in FIG. 7, to an open position, as illustrated in FIG. 8. In this embodiment, a receptacle 802 is revealed when the wing parts are in the open position (FIG. 8), and the receptacle is hidden from view when the wing parts are in the closed position (FIG. 7). Although not visible in FIG. 7 or 8, in one embodiment, there is a gear mechanism that connects the right and left wing parts, such that both wing parts move together in a synchronized manner, such as when the wing parts open and close.

Receptacles 302 and 802 can hold one or more candles, potpourri, or scented stones. In one embodiment, receptacle 302 or 802 is substantially the same diameter as a votive or tea candle (e.g., about 1.5 inches in diameter). In another embodiment, receptacle 302 or 802 is substantially larger than a votive or tea candle.

In the various embodiments, one or more of the body, head, wing and legs can be constructed of various materials, including glass, plastic, brass and other metals, such as copper, nickel, aluminum, etc. In the various embodiments, one or more of the body, head, wing and legs can be transparent, or translucent, or solid.

In another embodiment, a solar panel is integrated in the wing, head and/or body parts, to provide power for a light source located in the wing, head, body parts and/or receptacle.

In another embodiment, the body, head, and/or wing part is transparent or translucent, and a led light in the body, head, and/or wing part can be illuminated.

In another embodiment, one or more of the body, head, and/or wing parts have phosphorescent properties.

In another embodiment, the apparatus has an electrical plug, and a heated scent diffuser.

In another embodiment, the apparatus has an internal power source, such as a battery, and a scent diffuser that is powered by the internal power source.

In another embodiment, the wing parts are rotabably attached to the body part, and lift up from the body part to reveal the receptacle in the body part.

In another embodiment, the receptacle is sized to hold solid perfume.

In another embodiment, the apparatus has a sprayer in the head part, and a receptacle to hold liquid perfume.

In another embodiment, that apparatus is configured so it can be attached to or adhered to a wall.

In FIGS. 1-8, the apparatus represents a scarab. In other embodiments, the apparatus represents other types of insects or animals, such as the families of Coleoptera, Cicadellidae, Scutelleridae, Pentatomoidea, flies, spiders, moths, snakes, dragons, peacocks, owls, rams head, bee, ant, ladybug, grasshopper, dragonfly, or praying mantis.

Although illustrative embodiments have been described herein in detail, it should be noted and will be appreciated by those skilled in the art that numerous variations may be made within the scope of this invention without departing from the principle of this invention and without sacrificing its chief advantages. For example features that appear in one embodiment of a particular figure are also applicable to embodiments that are illustrated in other figures.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

1. An apparatus for containing materials, comprising:
a body part configured to represent an insect;
a plurality of wing parts movably attached to the body part and configured to swing in a substantially horizontal and coordinated manner between a closed position and an open position; and
a receptacle in the body part, wherein the receptacle is substantially covered by the wing parts when the wing parts are in the closed position, and the receptacle is substantially uncovered when the wing parts are in the open position.

2. An apparatus according to claim 1, further comprising a head part attached and adjacent to one end of the body part.

3. An apparatus according to claim 1, further comprising a plurality of leg parts attached and extending laterally from sides of the body part.

4. An apparatus according to claim 1, wherein the insect resembles a scarab.

5. An apparatus according to claim 1, wherein the insect resembles an insect in the family of Coleoptera.

6. An apparatus according to claim 1, wherein the insect resembles an insect from the group consisting of the families of Cicadellidae, Scutelleridae, and Pentatomoidea.

7. An apparatus according to claim 1, wherein the receptacle is about 1.5 inches in diameter.

8. An apparatus according to claim 1, wherein the body part is at least partly constructed of glass.

9. An apparatus according to claim 1, wherein the body part is at least partly constructed of brass.

10. An apparatus according to claim 1, wherein the plurality of wing parts comprise two wing parts that are at least partly constructed of brass.

11. An apparatus for containing materials, comprising:
a body part configured to represent an insect;
a wing part that is removably mated to the body part; and
a receptacle in the body part, wherein the receptacle is substantially covered by the wing part when the wing part is mated to the body part, and the receptacle is substantially uncovered when the wing part is not mated to the body part.

12. An apparatus according to claim 11, wherein the wing part and body part have at least two alignment protrusions and corresponding alignment spaces.

13. An apparatus according to claim 12, wherein one alignment protrusion is on the wing part, and one alignment protrusion is on the body part.

14. An apparatus according to claim 11, wherein the receptacle opening diameter is about 1.5 inches.

15. An apparatus according to claim 11, wherein the receptacle opening diameter is substantially larger about 1.5 inches.

16. An apparatus according to claim 11, wherein the body part and wing part are both constructed at least partly of brass.

17. An apparatus according to claim 11, wherein the insect resembles a scarab.

18. An apparatus for holding a candle and configured to represent a scarab, comprising:
a body part constructed of brass;
a head part on one end of the body part;
a plurality of leg parts that extend laterally from both sides of the body part;
a pair of movable wing parts constructed of brass that are rotationally attached to a back of the body part; and
a receptacle in the back of the body part about 1.5 inches in diameter, wherein the receptacle is substantially covered by the pair of movable wing parts when the wing parts are in a closed position, and the receptacle is substantially uncovered when the wing parts are in an open position.

19. The apparatus according to claim 18, further comprising a gear mechanism connecting the pair of movable wing parts, configured to synchronize movement of the pair of movable wing parts between the closed position and the open position.

20. An apparatus with a receptacle, configured to represent a scarab, comprising:
a body part constructed of brass;
a head part on one end of the body part;
a first protrusion on an end of the body part opposite the head part;
a plurality of leg parts that extend laterally from both sides of the body part;
a wing part constructed of brass;
a second protrusion on the wing part, wherein the first protrusion and the second protrusion are configured to allow the wing part to removably mate to a back of the body part; and
a receptacle in the back of the body part, wherein the receptacle is substantially covered by the wing part when the wing part is mated to the back of the body part, and the receptacle is substantially uncovered when the wing part is not mated to the back of the body part.
